(19) United States
(12) Patent Application Publication
(10) Pub. No.: US 2026/0045688 A1
(43) Pub. Date: Feb. 12, 2026

(54) ANTENNA APPARATUS, ANTENNA SYSTEM, AND COMMUNICATION DEVICE

(71) Applicant: HUAWEI TECHNOLOGIES CO., LTD., Shenzhen (CN)

(72) Inventors: Weihong Xiao, Dongguan (CN); Dingjiu Daojian, Dongguan (CN); He Cui, Dongguan (CN); Jia Lv, Shanghai (CN); Tao Pu, Shanghai (CN)

(21) Appl. No.: 19/362,578

(22) Filed: Oct. 20, 2025

Related U.S. Application Data
(63) Continuation of application No. PCT/CN2024/085242, filed on Apr. 1, 2024.

(30) Foreign Application Priority Data
Apr. 21, 2023 (CN) 202310463337.5

(51) Int. Cl. H01Q 3/30; H01Q 15/14; H01Q 19/10; H01Q 21/08

(52) U.S. Cl. CPC H01Q 3/30; H01Q 15/14; H01Q 19/10; H01Q 21/08

(57) ABSTRACT

Embodiments of this application provide an antenna apparatus, an antenna system, and a communication device. The antenna apparatus includes a reflection panel, a first feeding network, and a first radiating element. Both the first feeding network and the first radiating element are located on a first surface of the reflection panel, and the first radiating element is electrically connected to the first feeding network. The first feeding network includes a phase shift apparatus, and the phase shift apparatus is disposed at an included angle with the reflection panel. The antenna apparatus has a small cross-sectional height, to facilitate miniaturization development of the antenna apparatus; and has good antenna performance.

### CROSS-REFERENCE TO RELATED APPLICATIONS

This application is a continuation of International Application No. PCT/CN2024/085242, filed on Apr. 1, 2024, which claims priority to Chinese Patent Application No. 202310463337.5, filed on Apr. 21, 2023. The disclosures of the aforementioned applications are hereby incorporated by reference in their entireties.

### TECHNICAL FIELD

This application relates to the field of antenna technologies, and in particular, to an antenna apparatus, an antenna system, and a communication device.

### BACKGROUND

With rapid development of wireless communication technologies, a user has increasingly high requirements for a transmission speed and a transmission bandwidth of a network, and therefore has an increasingly high requirement for a capacity of a communication system. Therefore, a massive multiple input multiple output (MIMO) technology and a beamforming array antenna emerge. In a conventional base station array antenna, a radiating element of the antenna is electrically connected to a feeding network, and network coverage can be changed in real time by using a phase shifter in the feeding network, to meet a constant change of a coverage scenario, so that network performance is optimal.

In a related technology, as shown in FIG. 1, an antenna structure 10 includes a reflection panel 1, a radiating element 2, and a feeding network 3. The feeding network 3 includes a phase shifter 4. The radiating element 2 is disposed on one surface of the reflection panel 1. The feeding network 3 is usually disposed at two positions. One position is that the feeding network 3 is disposed on a surface that is of the reflection panel 1 and that faces away from the radiating element 2 (as shown in FIG. 1). The other position is that the feeding network 3 is disposed on the same surface of the reflection panel 1 as the radiating element 2 (as shown in FIG. 2). As shown in FIG. 1, when the feeding network 3 is disposed on the surface that is of the reflection panel 1 and that faces away from the radiating element 2, a cross-sectional height of the antenna structure 10 is large. This does not facilitate miniaturization development of the antenna structure 10.

However, as shown in FIG. 2, when the feeding network 3 is disposed on the same surface of the reflection panel 1 as the radiating element 2, because the phase shifter 4 is laid flat on the reflection panel 1, an area of the phase shifter 4 relative to the reflection panel 1 in a direction parallel to the reflection panel 1 is large. Therefore, an area of an induced current generated on a surface of the phase shifter 4 is large, and consequently electromagnetic interference is prone to be generated between the feeding network 3 and the radiating element 2. This affects working performance of the antenna structure 10.

### SUMMARY

Embodiments of this application provide an antenna apparatus, an antenna system, and a communication device. The antenna apparatus has a small cross-sectional height, to facilitate miniaturization development of the antenna apparatus; and has good antenna performance.

A first aspect of embodiments of this application provides an antenna apparatus, including a reflection panel, a first feeding network, and a first radiating element. Both the first feeding network and the first radiating element are located on a first surface of the reflection panel, and the first radiating element is electrically connected to the first feeding network. The first feeding network includes a phase shift apparatus, and the phase shift apparatus is disposed at an included angle with the reflection panel.

According to the antenna apparatus provided in this embodiment of this application, both the first feeding network and the first radiating element are disposed on the first surface of the reflection panel. Therefore, compared with a solution in which a feeding network and a radiating element are disposed on two surfaces of a reflection panel in a related technology, this can make the first feeding network and the first radiating element share a partial cross-sectional height, so that a cross-sectional height of the antenna apparatus can be reduced, to facilitate miniaturization development of the antenna apparatus. The first feeding network is designed to include the phase shift apparatus, and the phase shift apparatus is disposed at the included angle with the reflection panel. Therefore, compared with a solution in which a phase shifter is disposed parallel on the reflection panel in the related technology, this can reduce a projection area of the phase shift apparatus on the reflection panel, to reduce a projection area of an induced current formed on a surface of the phase shift apparatus on the reflection panel, thereby reducing electromagnetic interference between the first feeding network and the first radiating element, and improving antenna performance.

In a possible implementation, the phase shift apparatus includes a housing. The housing is disposed at the included angle with the reflection panel.

The phase shift apparatus is disposed to include the housing, to protect a phase shift medium and the like in the phase shift apparatus, thereby prolonging a service life of the phase shift apparatus. The housing is disposed at the included angle with the reflection panel. Therefore, compared with the solution in which the phase shifter is disposed parallel on the reflection panel in the related technology, this can reduce a projection area of the housing of the phase shift apparatus on the reflection panel, to reduce a projection area of an induced current formed on the housing of the phase shift apparatus on the reflection panel, thereby reducing electromagnetic interference between the first feeding network and the first radiating element, and improving antenna performance.

In a possible implementation, a side wall of the housing encloses a cavity structure. A partition board is disposed in the cavity structure, the partition board divides the cavity structure into a plurality of accommodating cavities, and a phase shift medium is disposed in each accommodating cavity.

The cavity structure enclosed by the housing is divided into the plurality of accommodating cavities, and the phase shift medium is disposed in each accommodating cavity, so that the phase shift apparatus can have a plurality of adjustment cavities, to be specific, a plurality of first radiating elements can be controlled by using a plurality of groups of phase shift media. Therefore, compared with a solution in which only one accommodating cavity is disposed, this can improve working efficiency of the phase shift apparatus.

In a possible implementation, each partition board is disposed at the included angle with the reflection panel. The phase shift medium is movably disposed in a direction of forming the included angle with the reflection panel.

The partition board is disposed at the included angle with the reflection panel, and the phase shift medium is movably disposed in the direction of forming the included angle with the reflection panel, so that the phase shift medium can move in the direction of forming the included angle with the reflection panel. Therefore, compared with the solution in which the phase shifter is disposed parallel on the reflection panel in the related technology, this can reduce projection areas of the partition board and the phase shift medium of the phase shift apparatus on the reflection panel, to reduce projection areas of induced currents formed on the partition board and the phase shift medium on the reflection panel, thereby reducing electromagnetic interference between the first feeding network and the first radiating element, and improving antenna performance.

In a possible implementation, the included angle is 90°.

The included angle is set to 90°, to be specific, an included angle between the phase shift apparatus and the reflection panel, an included angle between the housing and the reflection panel, an included angle between the partition board and the reflection panel, and an included angle between the phase shift medium and the reflection panel are all set to 90°. In this way, a projection area of the phase shift apparatus on the reflection panel can be the smallest, thereby minimizing electromagnetic interference between the phase shift apparatus and the first radiating element, and maximally improving antenna performance.

In a possible implementation, the first feeding network further includes a signal transmission part. The signal transmission part is electrically connected to the phase shift apparatus, and the first radiating element is electrically connected to the signal transmission part.

The signal transmission part is disposed, so that the phase shift apparatus can be electrically connected to first radiating elements located at different positions, to transmit a radio frequency signal to each first radiating element.

In a possible implementation, at least a partial structure of the signal transmission part is parallel to the first surface of the reflection panel.

In a possible implementation, a groove structure is disposed on the first surface of the reflection panel. An extension direction of the groove structure is the same as an extension direction of the signal transmission part on the reflection panel, and the signal transmission part is located in the groove structure.

A plurality of groove structures are disposed on the first surface of the reflection panel, and the signal transmission part is disposed in the groove structures, so that the signal transmission part is embedded in the reflection panel, in other words, the reflection panel and the signal transmission part can be designed in a fusion manner. In this way, space occupied by the first feeding network can be reduced, to facilitate miniaturization development of the antenna apparatus; and cabling on the reflection panel can be centralized in small space, to reduce interference of cabling of the signal transmission part to an electromagnetic signal of the antenna.

In a possible implementation, there are a plurality of first radiating elements. The plurality of first radiating elements are spaced apart in a direction in which the signal transmission part is located, and each first radiating element is electrically connected to the signal transmission part.

The plurality of first radiating elements are disposed, so that the antenna apparatus can form an array antenna, to obtain better radiation directivity, thereby improving a radiation efficiency of the antenna apparatus, and improving performance of the antenna apparatus.

In a possible implementation, the first feeding network and the plurality of first radiating elements connected to the first feeding network jointly form a first array unit. The phase shift apparatus is located between two adjacent first radiating elements in the first array unit.

The phase shift apparatus is disposed between the two adjacent first radiating elements in the first array unit, so that there can be a part of the first radiating elements on each of two sides of the phase shift apparatus. Therefore, compared with a solution in which the phase shift apparatus is disposed at one end of the first array unit, this can facilitate cabling, thereby reducing cabling difficulty.

In a possible implementation, a plurality of first array units are disposed in parallel on the first surface of the reflection panel, and there is a first gap between two adjacent first array units.

The plurality of first array units are disposed, so that better radiation directivity can be obtained, thereby improving a radiation efficiency of the antenna apparatus, and improving performance of the antenna apparatus. The first gap is disposed between two adjacent first array units, so that signal interference between two adjacent first array units can be reduced, thereby improving performance of the antenna apparatus.

In a possible implementation, the signal transmission part includes a plurality of signal transmission lines. Each first radiating element corresponds to one signal transmission line, one end of the signal transmission line is electrically connected to the phase shift apparatus, and the other end is electrically connected to the first radiating element.

In a possible implementation, a second radiating element and a second feeding network are further included. Both the second radiating element and the second feeding network are located on the first surface of the reflection panel, and the second radiating element is electrically connected to the second feeding network. A radiation frequency of the first radiating element is different from a radiation frequency of the second radiating element.

The second radiating element and the second feeding network are disposed, and the radiation frequency of the first radiating element is set to be different from the radiation frequency of the second radiating element, for example, the radiation frequency of the first radiating element is higher than the radiation frequency of the second radiating element, so that the antenna apparatus can radiate electromagnetic signals in different frequency bands, thereby improving a bandwidth of the antenna apparatus.

In a possible implementation, a plurality of second radiating elements are spaced apart on the first surface, and each second radiating element is connected to the second feeding network.

A second array unit is disposed, so that a frequency coverage area of the antenna apparatus can be improved, to obtain better radiation directivity, thereby improving a radiation efficiency of the antenna apparatus, and improving performance of the antenna apparatus.

In a possible implementation, the second feeding network and the plurality of second radiating elements connected to the second feeding network jointly form the second array unit. At least one second array unit is disposed between two adjacent first array units, and there is a second gap between an end that is of the second array unit and that is close to the reflection panel and each of the two adjacent first array units.

The second gap is disposed between two adjacent second array units, so that signal interference between two adjacent second array units can be reduced, thereby improving performance of the antenna apparatus.

In a possible implementation, an end that is of the phase shift apparatus and that is close to the reflection panel is fastened to the reflection panel.

The phase shift apparatus is fastened to the reflection panel, so that the first feeding network is fastened to the reflection panel, and the first radiating element connected to the first feeding network is fastened to the reflection panel, to ensure that the first radiating element can be stably connected to the reflection panel, thereby ensuring normal working of the antenna apparatus.

A second aspect of embodiments of this application provides an antenna system, including the antenna apparatus according to any one of the implementations of the first aspect. The antenna apparatus is a first antenna apparatus. The antenna system further includes a second antenna apparatus. The second antenna apparatus is disposed opposite to a second surface of the reflection panel of the first antenna apparatus, and the first surface and the second surface face away from each other.

The antenna system is disposed to include the first antenna apparatus and the second antenna apparatus, so that a plurality of antennas are designed in a fusion manner, to facilitate full-frequency-band coverage of the antenna apparatus. The phase shift apparatus of the first feeding network of the first antenna apparatus is disposed at the included angle with the reflection panel, so that a projection area of the phase shift apparatus on the reflection panel can be reduced, in other words, an overlapping area of projections of the phase shift apparatus of the first antenna apparatus and the second antenna apparatus on the reflection panel can be reduced. In this way, when the second antenna apparatus transmits an electromagnetic wave in a direction perpendicular to the reflection panel in a plane parallel to the reflection panel, interference of the phase shift apparatus to radiation of an active antenna signal can be reduced, thereby improving antenna performance.

In a possible implementation, the first antenna apparatus is a passive antenna apparatus, and the second antenna apparatus is an active antenna apparatus.

The first antenna apparatus is disposed as the passive antenna apparatus, and the second antenna apparatus is disposed as the active antenna apparatus, so that an active antenna and a passive antenna are designed in a fusion manner, to facilitate full-frequency-band coverage of the antenna apparatus.

In a possible implementation, the reflection panel of the first antenna apparatus is a frequency selective surface.

The reflection panel of the first antenna apparatus is disposed as the frequency selective surface, so that the reflection panel can transmit a signal of the second antenna apparatus and reflect a signal of the first antenna apparatus (the first radiating element and the second radiating element), thereby improving performance of the antenna system.

A third aspect of embodiments of this application provides a communication device, including the antenna apparatus according to any one of the implementations of the first aspect and a radio frequency unit. The antenna apparatus is connected to the radio frequency unit.

According to the communication device provided in this embodiment of this application, the antenna apparatus in the first aspect is disposed in the communication device, so that the communication device can have an advantage of the antenna apparatus, to facilitate miniaturization development of the communication device. In addition, interference between components of the antenna apparatus is small, so that performance of the communication device is better.

A fourth aspect of embodiments of this application provides a communication device, including the antenna system according to any one of the implementations of the second aspect and a radio frequency unit. The antenna system is connected to the radio frequency unit.

According to the communication device provided in this embodiment of this application, the antenna system in the second aspect is disposed in the communication device, so that the communication device can have an advantage of the antenna system, to facilitate full-frequency-band coverage of the antenna apparatus. In addition, interference between components of the antenna system is small, so that performance of the communication device is better.

### BRIEF DESCRIPTION OF DRAWINGS

FIG. 1 is a diagram of an antenna structure;

FIG. 2 is a diagram of another antenna structure;

FIG. 3 is a diagram of a structure of an antenna system of a communication device according to an embodiment of this application;

FIG. 4 is a diagram of a framework structure of an antenna apparatus according to an embodiment of this application;

FIG. 5 is a diagram of a structure of an antenna apparatus according to an embodiment of this application;

FIG. 6 is a diagram of a partial structure of an antenna apparatus according to an embodiment of this application;

FIG. 7 is a diagram of a structure of a first array unit of an antenna apparatus according to an embodiment of this application;

FIG. 8 is a diagram of a cross-sectional structure of an antenna apparatus according to an embodiment of this application;

FIG. 9 is a diagram of a cross-sectional structure of an antenna apparatus according to another embodiment of this application;

FIG. 10 is a diagram of a cross-sectional structure of a phase shift apparatus of a first feeding network of an antenna apparatus according to an embodiment of this application;

FIG. 11 is a diagram of a partial structure of an antenna apparatus according to another embodiment of this application;

FIG. 12 is a diagram of a cross-sectional structure of the antenna apparatus shown in FIG. 11;

FIG. 13 is a diagram of a cross-sectional structure of an antenna apparatus according to another embodiment of this application;

FIG. 14 is a diagram of a structure of an antenna system according to an embodiment of this application;

FIG. 15 is a diagram of a cross-sectional structure of an antenna system according to an embodiment of this application;

FIG. 16 is a diagram of a structure of an antenna system according to another embodiment of this application; and

FIG. 17 is a diagram of a structure of an antenna system according to still another embodiment of this application.

### DESCRIPTION OF REFERENCE NUMERALS

1000—communication device; 10—antenna structure; 100—antenna apparatus; 200—fastening support; and 300—pole;
400—grounding device; 2, 110—radiating element; 111—first radiating element; and 112—second radiating element;
1, 120—reflection panel; 120a—first surface; 120b—second surface; and 121—groove structure;
3, 130—feeding network; 4, 131—phase shifter; and 132—transmission or calibration network;
133—combiner or filter; 140—radome; and 150—antenna connector;
130a—first feeding network; 131a—phase shift apparatus; 1311a—housing; 1312a—partition board; and 1313a—accommodating cavity;
1314a—phase shift medium; 1315a—metal strip; and 1316a—cavity structure;
132a—signal transmission part; and 130b—second feeding network;
170—first array unit; and 180—second array unit; and
500—antenna system; 510—first antenna apparatus; and 520—second antenna apparatus.

### DESCRIPTION OF EMBODIMENTS

Terms used in implementations of this application are only used to explain specific embodiments of this application, but are not intended to limit this application.

Unless otherwise required in the context, throughout this specification and claims, the term “include (comprise)” and other forms of the term, for example, a third person singular form “includes (comprises)” and a present participle form “including (comprising)”, are interpreted as “open and inclusive”, namely, “include but not limited to”. In description of this specification, terms such as “one embodiment”, “some embodiments”, “example embodiments”, “example”, or “some examples” are intended to indicate that a particular feature, structure, material, or characteristic related to this embodiment or example are included in at least one embodiment or example of this disclosure. The foregoing schematic representations of the terms do not necessarily refer to a same embodiment or example. Further, the particular feature, structure, material, or characteristic may be included in any one or more embodiments or examples in any appropriate manner.

Moreover, in this application, position terms such as “front” and “back” are defined relative to schematic placement positions of components in the accompanying drawings. It should be understood that these direction terms are relative concepts and are used for relative description and clarification, and may accordingly change based on a change of the placement positions of the components in the accompanying drawings.

In embodiments of this application, “and/or” describes only an association relationship between associated objects and indicates that three relationships may exist. For example, A and/or B may indicate the following three cases: Only A exists, both A and B exist, and only B exists. In addition, the character “/” in this specification generally indicates an “or” relationship between the associated objects.

An antenna apparatus, an antenna system, and a communication device provided in embodiments of this application may be used in various communication systems. For example, the communication system may be a long term evolution (LTE) system, a 5th generation (5G) communication system, a 6th generation (6G) communication system, a global system for mobile communications (GSM), a code division multiple access (CDMA) system, a wideband code division multiple access (WCDMA) system, a general packet radio service (GPRS) system, an LTE time division duplex (TDD) system, or a universal mobile telecommunication system (UMTS), or a worldwide interoperability for microwave access (WiMAX) communication system. Certainly, the antenna apparatus and the communication device in embodiments of this application may alternatively be used in another communication system. This is not limited herein.

The communication device provided in embodiments of this application may include the antenna apparatus in the first aspect and a radio frequency unit, and the antenna apparatus may be connected to the radio frequency unit; or include the antenna system in the second aspect and a radio frequency unit, and the antenna system may be connected to the radio frequency unit. The radio frequency unit may input a radio frequency signal into the antenna apparatus or the antenna system, so that the antenna apparatus or the antenna system can radiate an electromagnetic signal outwards.

The communication device provided in this application may be a base station. The base station may be a device configured to communicate with a terminal device, including a base transceiver station (BTS) in a global system for mobile communications (GSM) or code division multiple access (CDMA), may be a NodeB (NB) in a wideband code division multiple access (WCDMA) system, may be an evolved NodeB (eNB or eNodeB) in an LTE system, or may be a radio controller in a cloud radio access network (CRAN) scenario. Alternatively, the base station may include a relay station, an access point, a vehicle-mounted device, a wearable device, a base station in a future 5G network, a base station in a future evolved public land mobile network (PLMN), or the like. This is not limited in this embodiment of this application.

The following provides descriptions by using an example in which the communication device in embodiments of this application is a base station and the communication system includes the antenna apparatus in the first aspect. A main component for transmitting information between the base station and a mobile device is the antenna apparatus or an antenna system. Generally, as shown in FIG. 3, a communication device 1000 may include an antenna apparatus 100, a fastening support 200, a pole 300, a grounding device 400, and the like. The antenna apparatus 100 is fastened to the pole 300 by using the fastening support 200. During actual application, a position and an installation angle of the antenna apparatus 100 on the pole 300 may be adjusted by adjusting a position and an angle of the fastening support 200.

In addition, an end of the antenna apparatus 100 may be further connected to the grounding device 400 through a connecting piece, to ensure that the antenna apparatus 100 is grounded. A connector sealing piece is disposed at each of an end that is of the connecting piece and that is connected to the antenna apparatus 100 and an end that is of the connecting piece and that is connected to the grounding device 400, to ensure connection sealing between the two ends of the connecting piece and the antenna apparatus 100 and the grounding device 400. It may be understood that the connector sealing piece may be an insulation sealing tape, for example, a polyvinyl chloride (PVC) insulation tape.

During specific application, the antenna apparatus 100 is usually located in a radome. The radome is a cover structure outside the antenna apparatus 100. The radome is a structural piece that protects the antenna apparatus 100 from being affected by an external environment. The radome has a good electromagnetic wave penetration characteristic in electrical performance, and can withstand an effect of an external harsh environment in mechanical performance. The antenna apparatus 100 is protected by using the radome, to prevent the antenna apparatus 100 from being damaged due to dust or water.

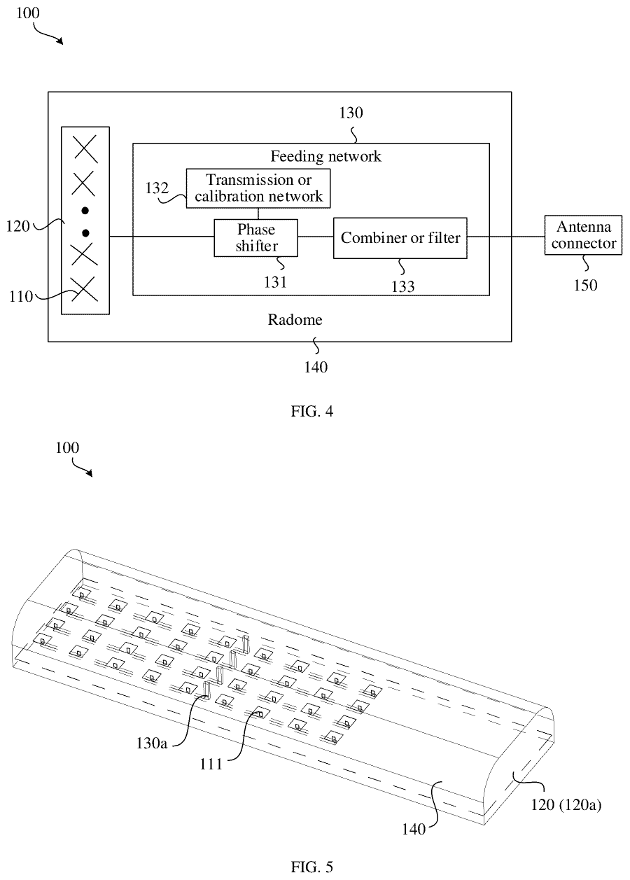

As shown in FIG. 4, an antenna apparatus 100 in an embodiment of this application may include at least one independent array including radiating elements 110 and a reflection panel 120. Radiation frequencies of different radiating elements 110 may be the same or different. The radiating element 110 is usually placed on the reflection panel 120. The array receives or transmits a radio frequency signal via a feeding network 130 of the array.

The feeding network 130 may feed a radio frequency signal to the radiating element 110 based on a specific amplitude and phase, or send a received radio signal to a signal processing unit of a radio frequency device, for example, a communication base station, based on a specific amplitude and phase. The feeding network 130 may include a phase shifter 131 connected to the radiating element 110. The phase shifter 131 is configured to implement real-time variability of network coverage, and adjust a signal phase, to implement an electrical downtilt of an array antenna.

In addition, in some embodiments, the phase shifter 131 may be connected to a transmission or calibration network 132. The feeding network 130 implements directions of different radiation beams by using a transmission component, and the feeding network 130 is connected to the calibration network to obtain a calibration signal required by a system. The feeding network 130 may further include a module configured to extend performance, such as a combiner or filter 133, thereby improving performance of the antenna apparatus 100.

The antenna apparatus 100 is located in a radome 140 and is connected to an antenna connector 150. For example, an end that is of the antenna connector 150 and that is away from the feeding network 130 may be electrically connected to a radio frequency circuit (not shown in the figure), so that a radio frequency signal is transmitted between the radiating element 110 and the radio frequency circuit. For example, the other end of the antenna connector 150 is electrically connected to a radio frequency signal port in the radio frequency circuit.

When the antenna apparatus 100 is a transmit antenna, the radio frequency circuit may provide a signal source for the antenna apparatus 100. For example, the other end of the antenna connector 150 may be electrically connected to the radio frequency signal port in the radio frequency circuit, in other words, the feeding network 130 is electrically connected to the radio frequency signal port in the radio frequency circuit. In this way, the radio frequency signal port may send a radio frequency signal, and feed the radio frequency signal into the radiating element 110 in a form of a current. Then, the radiating element 110 sends the radio frequency signal in a form of an electromagnetic wave, and the radio frequency signal is received by a receive antenna in a mobile device.

When the antenna apparatus 100 is a receive antenna, the radio frequency circuit may receive a radio frequency signal fed back by the antenna apparatus 100. For example, the radiating element 110 of the antenna apparatus 100 converts a received electromagnetic wave signal into a current signal, and then transmits the current signal to the radio frequency circuit via the feeding network 130. Then, a signal processing unit performs subsequent processing.

The radio frequency circuit includes a remote radio unit (remote radio unit, RRU for short), in other words, the remote radio unit is a part of the radio frequency circuit. The radio frequency signal port is usually disposed in the remote radio unit. For specific circuit settings and a working principle of the radio frequency circuit, directly refer to related content in a conventional technology. Details are not described herein.

During actual application, with wide application and development of 5G technologies, a base station antenna develops toward a plurality of bands and a plurality of arrays, and integration of the antenna apparatus is increasingly high. For example, the antenna apparatus may include a plurality of radiating elements 110 and a plurality of feeding networks 130, and the feeding networks 130 and the radiating elements 110 are disposed in one-to-one correspondence, so that the antenna apparatus 100 forms an array antenna. Each radiating element 110 is electrically connected to a feeding network 130 corresponding to the radiating element 110, so that each radiating element 110 is electrically connected to the radio frequency circuit through the feeding network 130 of the radiating element 110, and each radiating element 110 receives or sends a radio frequency signal.

The following describes in detail the antenna apparatus 100 in this embodiment of this application with reference to the accompanying drawings.

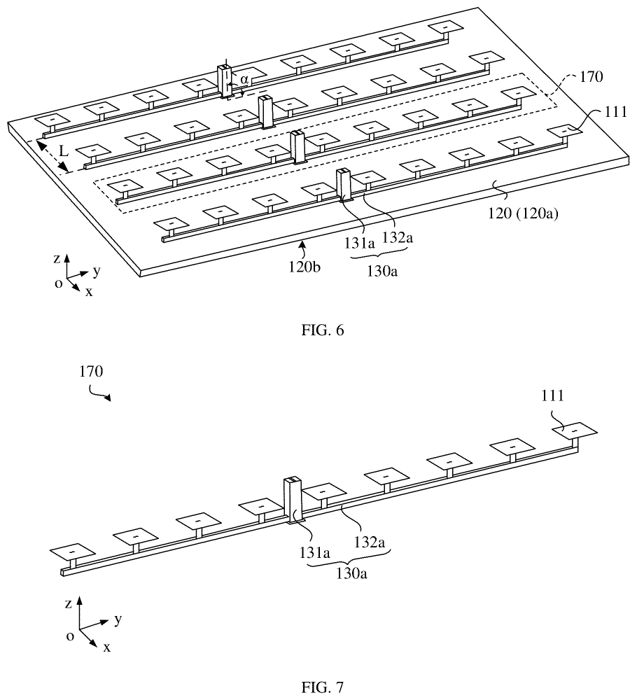

FIG. 5 is a diagram of a structure of an antenna apparatus according to an embodiment of this application. FIG. 6 is a diagram of a partial structure of an antenna apparatus according to an embodiment of this application. FIG. 7 is a diagram of a structure of a first array unit of an antenna apparatus according to an embodiment of this application.

As shown in FIG. 5, an embodiment of this application provides an antenna apparatus 100, which is an array antenna. The antenna apparatus 100 may include a reflection panel 120, a first feeding network 130a, a first radiating element 111, and a radome 140. The reflection panel 120, the first feeding network 130a, and the first radiating element 111 are all disposed in the radome 140.

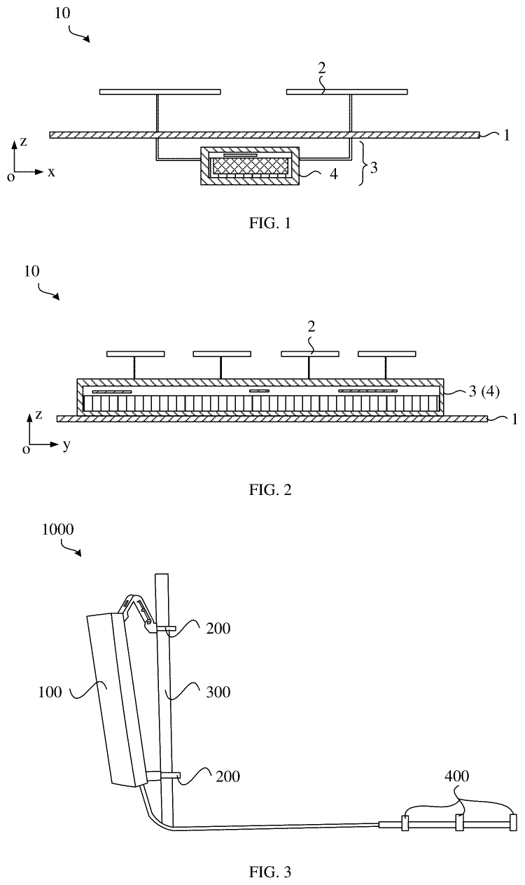

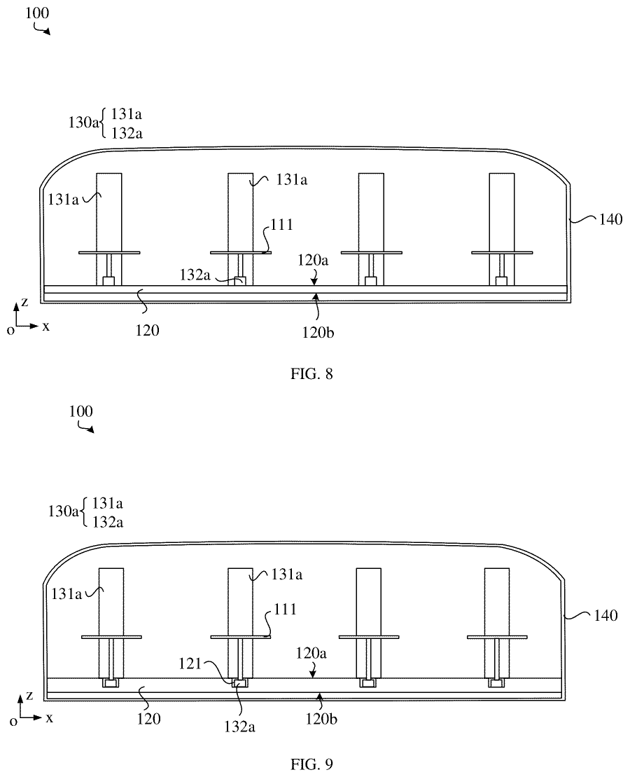

As shown in FIG. 6, both the first feeding network 130a and the first radiating element 111 are located on a first surface 120a of the reflection panel 120. According to the antenna apparatus 100 provided in this embodiment of this application, both the first feeding network 130a and the first radiating element 111 are disposed on the first surface 120a of the reflection panel 120. Therefore, compared with the solution in which the feeding network 3 and the radiating element 2 are disposed on two surfaces of the reflection panel 1 in the related technology (referring to FIG. 1), this can make the first feeding network 130a and the first radiating element 111 share a partial cross-sectional height (referring to FIG. 8), so that a cross-sectional height of the antenna apparatus 100 can be reduced, to facilitate miniaturization development of the antenna apparatus 100.

The first feeding network 130a includes a phase shift apparatus 131a, and the phase shift apparatus 131a is disposed at an included angle with the first surface 120a of the reflection panel 120. In some embodiments, an included angle between the phase shift apparatus 131a and the first surface 120a of the reflection panel 120 is 90° (referring to an angle α in FIG. 6. Certainly, the included angle may alternatively be represented at another position, and the included angle is merely an example and does not represent a real included angle between the phase shift apparatus 131a and the reflection panel 120).

The phase shift apparatus 131a is disposed at the included angle with the reflection panel 120. Therefore, compared with the solution in which the phase shifter 4 and the radiating element 2 are disposed on the same surface of the reflection panel 1 and the phase shifter 4 is disposed in parallel to the reflection panel 1 in the related technology (referring to FIG. 2), this makes a projection area of the phase shift apparatus 131a on the reflection panel 120 in this embodiment of this application small, to reduce a projection area of an induced current formed on a surface of a housing of the phase shift apparatus 131a on the reflection panel 120. Because the first radiating element 111 radiates an electromagnetic wave outwards in a direction z (a direction perpendicular to the reflection panel 120) in a plane parallel to the reflection panel 120, a smaller projection area of the induced current of the phase shift apparatus 131a on the reflection panel 120 indicates a smaller overlapping area of projections of the phase shift apparatus 131a and the first radiating element 111 on the reflection panel 120 and therefore indicates smaller electromagnetic interference of the phase shift apparatus 131a to the first radiating element 111, thereby improving antenna performance.

In addition, the phase shift apparatus 131a of the first feeding network 130a is disposed perpendicular to the first surface 120a. In this way, a projection area of the first feeding network 130a on the reflection panel 120 can be minimized, and an area that is of the reflection panel 120 and that is used to carry the phase shift apparatus 131a can be reduced, thereby reducing an area of the reflection panel 120, to facilitate miniaturization development of the antenna apparatus 100.

It should be noted that, in a related technology, referring to FIG. 2, a housing of the phase shifter 4 may be a metal housing. Therefore, when the phase shifter 4 and the radiating element 2 are disposed on the same surface of the reflection panel 1, because an induced current is generated on a surface of the metal housing of the phase shifter 4 when the radiating element 2 radiates an electromagnetic wave, a larger area of the phase shifter 4 relative to the reflection panel 1 indicates a larger distribution area of the induced current on the reflection panel 1 and therefore indicates larger impact on the radiating element 2.

Certainly, in some embodiments, the included angle between the phase shift apparatus 131a and the first surface 120a of the reflection panel 120 may alternatively be another value, for example, 45°, 60°, 75°, 85°, 89°, 91°, 95°, or 100°. Provided that the phase shift apparatus 131a is disposed at a specific included angle with the reflection panel 120, a projection area of the phase shift apparatus 131a on the reflection panel 120 can be reduced, thereby reducing electromagnetic interference of the phase shift apparatus 131a to the first radiating element 111, and improving antenna performance.

In some embodiments, the first feeding network 130a further includes a signal transmission part 132a. The signal transmission part 132a is electrically connected to the phase shift apparatus 131a, the first radiating element 111 is electrically connected to the signal transmission part 132a, and at least a partial structure of the signal transmission part 132a may be parallel to the first surface 120a. A phase shift medium (not shown in the figure) may be disposed in the phase shift apparatus 131a, and the phase shift medium may be movably disposed in a direction (the direction z) perpendicular to the first surface 120a. One end of the first radiating element 111 is electrically connected to the signal transmission part 132a, and the other end is spaced apart from the first surface 120a, so that the first radiating element 111 has a function of radiating an electromagnetic signal outwards. The phase shift apparatus 131a may be configured to: when the phase shift medium moves in the direction perpendicular to the first surface 120a, change a phase of a radio frequency signal entering the signal transmission part 132a. The signal transmission part 132a is configured to transmit the radio frequency signal to the first radiating element 111.

It should be noted that the phase shift apparatus 131a in this embodiment of this application has a same function as the phase shifter in the related technology. In some embodiments, the phase shift apparatus 131a may alternatively be used as a phase shifter.

It should be noted that a field strength direction of the first radiating element 111 is parallel to the reflection panel 120, and a propagation direction of an electromagnetic signal of the first radiating element 111 is perpendicular to the field strength direction, in other words, the electromagnetic signal of the first radiating element 111 is transmitted in the direction perpendicular to the reflection panel 120. Therefore, that the phase shift apparatus 131a is disposed perpendicular to the reflection panel 120 is equivalent to that the phase shift apparatus 131a is made parallel to the propagation direction of the electromagnetic signal of the first radiating element 111. Therefore, interference between the electromagnetic signal generated by the first radiating element 111 and the phase shift apparatus 131a can be effectively reduced, so that when the first feeding network 130a is placed on a same side as the first radiating element 111, performance of the antenna apparatus 100 can be significantly improved. In some embodiments, finally, a gain of the antenna apparatus 100 may be reduced to less than 0.3 dB due to impact of the phase shift apparatus 131a.

In some embodiments, as shown in FIG. 7, there are a plurality of first radiating elements 111. The plurality of first radiating elements 111 are spaced apart in an extension direction (a direction y) of the signal transmission part 132a, and each first radiating element 111 is electrically connected to the signal transmission part 132a. The first feeding network 130a and the first radiating elements 111 connected to the same first feeding network 130a jointly form a first array unit 170.

For example, each antenna apparatus 100 may include a plurality of first array units 170. The plurality of first array units 170 are disposed in parallel on a first surface 120a of a reflection panel 120, and there is a first gap L between two adjacent first array units 170. For example, the antenna apparatus 100 provided in this embodiment of this application includes four first array units 170. The four first array units 170 are disposed in parallel in a direction x, and a first gap L is disposed between two adjacent first array units 170.

It should be noted that, in this embodiment of this application, a quantity of first radiating elements 111 in each first array unit 170 is not limited; and may be 9 shown in the figure, and certainly may alternatively be 5, 6, 7, 8, 10, 11, or more. In this embodiment of this application, the quantity of first radiating elements 111 in each first array unit 170 is not limited. In addition, a quantity of first array units 170 in each antenna apparatus 100 is not limited in this embodiment of this application, either, for example, may be 1, 2, 3, 4, 5, or more. This may be specifically set based on a capacity of the antenna apparatus 100. This is not further limited in this embodiment of this application.

In addition, in this embodiment of this application, a value of the first gap L between two adjacent first array units 170 is not further limited, provided that no mutual interference is generated between first radiating elements 111.

In this embodiment of this application, the plurality of first radiating elements 111 are disposed, so that the antenna apparatus 100 can form an array antenna, to obtain better radiation directivity, thereby improving a radiation efficiency of the antenna apparatus 100, and improving performance of the antenna apparatus 100.

The plurality of first array units 170 are disposed, so that better radiation directivity can be obtained, thereby improving a radiation efficiency of the antenna apparatus 100, and improving performance of the antenna apparatus 100. The first gap L is disposed between two adjacent first array units 170, so that signal interference between two adjacent first array units 170 can be reduced, thereby improving performance of the antenna apparatus 100.

In some embodiments, as shown in FIG. 7, the phase shift apparatus 131a may be located between two adjacent first radiating elements 111 in the first array unit 170. For example, the phase shift apparatus 131a is located at a middle position of the first array unit 170. In the direction y, there are four first radiating elements 111 on one side of the phase shift apparatus 131a, and there are five first radiating elements 111 on the other side of the phase shift apparatus 131a. Certainly, in another embodiment, the phase shift apparatus 131a may alternatively be disposed at another position. For example, there may be three first radiating elements 111 on one side of the phase shift apparatus 131a, and there may be six first radiating elements 111 on the other side of the phase shift apparatus 131a; or the phase shift apparatus 131a may be disposed at one end of the first array unit 170. In this embodiment, a disposition position of the phase shift apparatus 131a is not further described.

The phase shift apparatus 131a is disposed between the two adjacent first radiating elements 111 in the first array unit 170, so that there can be a part of the first radiating elements 111 on each of two sides of the phase shift apparatus 131a. Therefore, compared with a solution in which the phase shift apparatus 131a is disposed at one end of the first array unit 170, this can reduce space required for cabling between the first radiating element 111 and the phase shift apparatus 131a, thereby reducing cabling difficulty between the first radiating element 111 and the phase shift apparatus 131a.

It should be noted that each first radiating element 111 is electrically connected to the phase shift apparatus 131a through the signal transmission part 132a. A function of the signal transmission part 132a is to transmit radio frequency signals in the phase shift apparatus 131a to first radiating elements 111 at different positions. Therefore, in some embodiments, the signal transmission part 132a may include a plurality of signal transmission lines (not shown in the figure). Each first radiating element 111 corresponds to one signal transmission line, one end of the signal transmission line is electrically connected to the phase shift apparatus 131a, and the other end is electrically connected to the first radiating element 111. The signal transmission line may be a coaxial line, a metal strip, or the like. A form of the signal transmission line is not further limited in this embodiment of this application, provided that signal transmission can be implemented.

In some embodiments, when lengths of signal transmission lines between the phase shift apparatus 131a and all the first radiating elements 111 are equal, phases of radio frequency signals input by the phase shift apparatus 131a into all the first radiating elements 111 are the same. Therefore, to ensure that phases of radio frequency signals in a plurality of first radiating elements 111 in a same first array unit 170 are the same, lengths of signal transmission lines between a phase shift apparatus 131a and all the first radiating elements 111 may be set to be equal.

Usually, the signal transmission line is disposed between the phase shift apparatus 131a and the first radiating element 111. Because a distance from a first radiating element 111 closer to the phase shift apparatus 131a to the phase shift apparatus 131a is smaller, space for disposing the signal transmission line is also smaller. For example, if a signal transmission line between a first radiating element 111 closest to the phase shift apparatus 131a and the phase shift apparatus 131a is disposed to have a same length as a signal transmission line between a first radiating element 111 farthest from the phase shift apparatus 131a and the phase shift apparatus 131a, space other than space between the first radiating element 111 and the phase shift apparatus 131a is required for laying the signal transmission line between the first radiating element 111 closest to the phase shift apparatus 131a and the phase shift apparatus 131a.

The phase shift apparatus 131a is disposed between the two adjacent first radiating elements 111 in the first array unit 170, so that the plurality of first radiating elements 111 can be disposed on the two sides of the phase shift apparatus 131a. This can reduce a distance difference between different first radiating elements 111 and the phase shift apparatus 131a, to reduce cabling space other than cabling space between the first radiating element 111 and the phase shift apparatus 131a, thereby reducing cabling complexity and reducing cabling difficulty. It may be understood that more complex cabling causes greater interference to an electromagnetic signal of the antenna apparatus.

In some embodiments, a plurality of cabling apparatus (not shown in the figure) disposed in the direction z may be disposed on a second surface 120b of the reflection panel 120, and a part of the signal transmission line in the signal transmission part 132a may be disposed in the cabling apparatus in the direction z, so that the lengths of the signal transmission lines between the phase shift apparatus 131a and all the first radiating elements 111 are set to be equal.

The cabling apparatus is disposed in the direction z, and the part of the signal transmission line or transmission strip in the signal transmission part may be disposed in the cabling apparatus in the direction z, so that a projection area of the signal transmission line or transmission strip on the reflection panel 120 can be reduced, thereby reducing a projection area of an induced current generated on the signal transmission line or transmission strip on the reflection panel 120, and reducing interference of the signal transmission line or transmission strip to an electromagnetic signal of the antenna apparatus.

In some embodiments, the signal transmission part 132a may be a coaxial line, a transmission strip, or another structure. In this embodiment of this application, a specific structure of the signal transmission part 132a is not further limited.

As shown in FIG. 8, the signal transmission part 132a may be disposed on the first surface of the reflection panel 120, or may be designed in a fusion manner with the reflection panel 120 (referring to FIG. 9). A plurality of groove structures 121 are disposed on the first surface 120a of the reflection panel 120. An extension direction of the groove structure 121 is the same as an extension direction of the signal transmission part 132a, and both the extension directions are the direction y. The signal transmission part 132a is located in the groove structures 121, so that the signal transmission part 132a is embedded in the reflection panel 120. In this way, the reflection panel 120 and the signal transmission part 132a can be designed in a fusion manner, so that a structure of the antenna apparatus 100 is simpler, and cabling on the reflection panel 120 can be concentrated in small space, to reduce interference of cabling of the signal transmission part 132a to an electromagnetic signal of the antenna.

It should be noted that the groove structure 121 shown in FIG. 8 is merely an example of a fused design of the signal transmission part 132a and the reflection panel 120. In an actual case, the groove structure 121 may alternatively be another structure. In this embodiment of this application, a specific shape of the groove structure 121 is not further limited.

In this embodiment of this application, a disposition position of the signal transmission part 132a is not further limited.

In this embodiment of this application, the phase shift apparatus 131a may include a housing 1311a. The housing 1311a is disposed at the included angle with the reflection panel 120. A side wall of the housing 1311a encloses a cavity structure 1316a. At least one partition board 1312a is disposed in the cavity structure 1316a. The at least one partition board 1312a divides the cavity structure 1316a into a plurality of accommodating cavities 1313a. A phase shift medium 1314a is disposed in each accommodating cavity 1313a. Each partition board 1312a is disposed at the included angle with the reflection panel 120. The phase shift medium 1314a is movably disposed in a direction of forming the included angle with the reflection panel 120. It may be understood that, an included angle between the housing 1311a and the reflection panel 120, an included angle between the partition board 1312a and the reflection panel 120, and an included angle between the phase shift medium 1314a and the reflection panel 120 are all the same as, in other words, all have a same value as, an included angle between the phase shift apparatus 131a and the reflection panel 120.

The phase shift apparatus 131a is disposed to include the housing 1311a, to protect the phase shift medium 1314a in the phase shift apparatus 131a, thereby prolonging a service life of the phase shift apparatus 131a. The housing 1311a is disposed at the included angle with the reflection panel 120. Therefore, compared with the solution in which the phase shifter is disposed parallel on the reflection panel in the related technology, this can reduce a projection area of the housing 1311a of the phase shift apparatus 131a on the reflection panel 120, to reduce a projection area of an induced current formed on the housing 1311a of the phase shift apparatus 131a on the reflection panel 120, thereby reducing electromagnetic interference between the first feeding network 130a and the first radiating element 111, and improving antenna performance.

The partition board 1312a is disposed at the included angle with the reflection panel 120, and the phase shift medium 1314a is movably disposed in the direction of forming the included angle with the reflection panel 120, so that the phase shift medium 1314a can move in the direction of forming the included angle with the reflection panel 120. Therefore, compared with the solution in which the phase shifter is disposed parallel on the reflection panel in the related technology, this can reduce projection areas of the partition board 1312a and the phase shift medium 1314a of the phase shift apparatus on the reflection panel 120, to reduce projection areas of induced currents formed on the partition board 1312a and the phase shift medium 1314a on the reflection panel 120, thereby reducing electromagnetic interference between the first feeding network 130a and the first radiating element 111, and improving antenna performance.

The cavity structure 1316a enclosed by the housing 1311a is divided into the plurality of accommodating cavities 1313a, so that the phase shift apparatus 131a can have a plurality of adjustment cavities, to be specific, a plurality of first radiating elements 111 are controlled by using a plurality of groups of phase shift media 1314a. Therefore, compared with a solution in which only one accommodating cavity 1313a is disposed, this can improve working efficiency of the phase shift apparatus 131a.

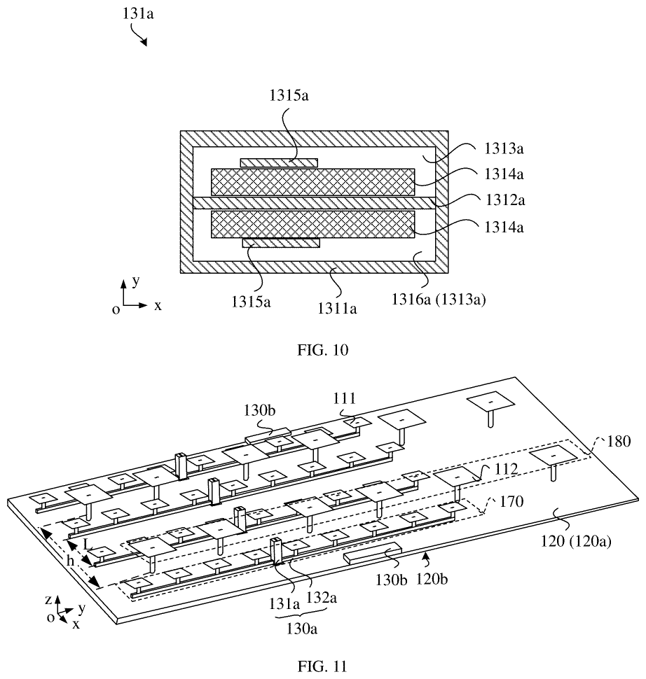

FIG. 10 is a diagram of a cross-sectional structure of the phase shift apparatus 131a in a direction parallel to the reflection panel 120. As shown in FIG. 10, the phase shift apparatus 131a may further include a housing 1311a. A side wall of the housing 1311a encloses a cavity structure 1316a. One partition board 1312a is disposed in the cavity structure 1316a. The partition board 1312a is perpendicular to the reflection panel 120, and divides the cavity structure 1316a into two accommodating cavities 1313a. A phase shift medium 1314a is disposed in each accommodating cavity 1313a. For example, different first radiating elements 111 may be controlled by using phase shift media 1314a in different accommodating cavities 1313a.

In another embodiment of this application, two, three, four, or more partition boards 1312a may be disposed in the phase shift apparatus 131a, and included angles between all the partition boards 1312a and the reflection panel 120 are equal. For example, each partition board 1312a is perpendicular to the reflection panel 120. Therefore, the cavity structure 1316a can be divided into a plurality of accommodating cavities 1313a. A phase shift medium is disposed in each accommodating cavity 1313a. In this way, the phase shift apparatus 131a can have a plurality of cavities that can implement a phase shift, thereby improving working efficiency of the phase shift apparatus 131a.

In this embodiment of this application, a quantity of partition boards 1312a in the phase shift apparatus 131a is not further limited, and may be 1, 2, 3, 4, or more. This may be specifically set based on a specific case.

It should be noted that, a metal strip 1315a may be further disposed in the phase shift apparatus 131a, to transmit a radio frequency signal. In this embodiment of this application, neither a material of the phase shift medium 1314a nor a shape of the metal strip 1315a in the phase shift apparatus 131a is further limited. These may be specifically set based on a specific case, provided that the phase shift medium 1314a can move in the direction z.

In a possible implementation, an end that is of the phase shift apparatus 131a and that is electrically connected to the signal transmission part 132a may be fastened to the reflection panel 120. The phase shift apparatus 131a is fastened to the reflection panel 120, so that the first feeding network 130a is fastened to the reflection panel 120, and the first radiating element 111 connected to the first feeding network 130a is fastened to the reflection panel 120, to ensure that the first radiating element 111 can be stably connected to the reflection panel 120, thereby ensuring normal working of the antenna apparatus 100.

In a possible implementation, the reflection panel 120 may be a metal reflection panel 120. The reflection panel 120 is disposed as the metal reflection panel 120, so that receiver sensitivity of the antenna apparatus 100 for an antenna signal can be improved, and the antenna signal can be reflected and aggregated on a receiving point. This greatly enhances a receiving or transmitting capability of the antenna apparatus 100, and also can block and shield an interference effect of another electromagnetic wave from the second surface 120b of the reflection panel 120 to the received signal.

In this embodiment of this application, a specific material of the metal reflection panel 120 is not further limited.

As shown in FIG. 11, in some embodiments, the antenna apparatus 100 may further include a second radiating element 112 and a second feeding network 130b. One end of the second radiating element 112 is electrically connected to the second feeding network 130b, and the other end is spaced apart from the first surface 120a. Both the second radiating element 112 and the second feeding network 130b are located on the first surface 120a of the reflection panel 120, and a radiation frequency of the first radiating element 111 is different from a radiation frequency of the second radiating element 112. For example, the radiation frequency of the first radiating element 111 is higher than the radiation frequency of the second radiating element 112.

In some embodiments, the second feeding network 130b is electrically connected to the second radiating element 112 (this is not shown in the figure), and the second feeding network 130b is configured to control a phase of a radio frequency signal entering the second radiating element 112. For example, the second feeding network 130b may be disposed on an outer side of the first radiating element 111 and the second radiating element 112, in other words, the second feeding network 130b may be disposed at a position that is of the reflection panel 120 and that is close to an outer edge. In this way, interference of the second feeding network 130b to an electromagnetic signal of the antenna apparatus 100 can be reduced. In some embodiments, the second feeding network 130b may be disposed in parallel to the reflection panel 120. Certainly, in some other embodiments, a partial structure of the second feeding network 130b may be disposed perpendicular to the reflection panel 120. For details, refer to the disposition manner of the first feeding network 130a. In this embodiment of this application, a specific shape, disposition position, and disposition manner of the second feeding network 130b are not further limited.

For example, both the first radiating element 111 and the second radiating element 112 may be square radiating elements. In some embodiments, the radiation frequency of the second radiating element 112 is lower than the radiation frequency of the first radiating element 111. Therefore, a size of the second radiating element 112 may be set to be greater than a size of the first radiating element 111.

In some embodiments, the first radiating element 111 and the second radiating element 112 may be alternately disposed. In this way, an overlapping area of projections of the first radiating element 111 and the second radiating element 112 on the reflection panel 120 can be reduced, thereby reducing mutual interference between the first radiating element 111 and the second radiating element 112. For example, in the direction y, the second radiating element 112 may be disposed between two first radiating elements 111, and in the direction x, the second radiating element 112 is disposed between two adjacent first array units 170.

Certainly, in another embodiment, the first radiating element 111 and the second radiating element 112 may alternatively be arranged in another arrangement manner. In this embodiment of this application, an arrangement manner of the first radiating element 111 and the second radiating element 112 is not further limited.

The second radiating element 112 and the second feeding network 130b are disposed, and the radiation frequency of the first radiating element 111 is set to be higher than the radiation frequency of the second radiating element 112, so that the antenna apparatus 100 can radiate electromagnetic signals in different frequency bands, thereby improving a bandwidth of the antenna apparatus 100, and improving applicability of the antenna apparatus 100.

In some embodiments, a height h1 of the second radiating element 112 in the direction z is greater than a height h3 of the first radiating element 111 in the direction z. In this way, the second radiating element 112 and the first radiating element 111 can be strewn at random in the direction z, so that a length of the reflection panel 120 in the direction x can be reduced, to facilitate miniaturization development of the antenna apparatus 100.

Certainly, in some other embodiments, the height h3 of the first radiating element 111 in the direction z may alternatively be set to be greater than the height h1 of the second radiating element 112 in the direction z (this is not shown in the figure). In this embodiment of this application, the heights of the first radiating element 111 and the second radiating element 112 in the direction z are not further limited.

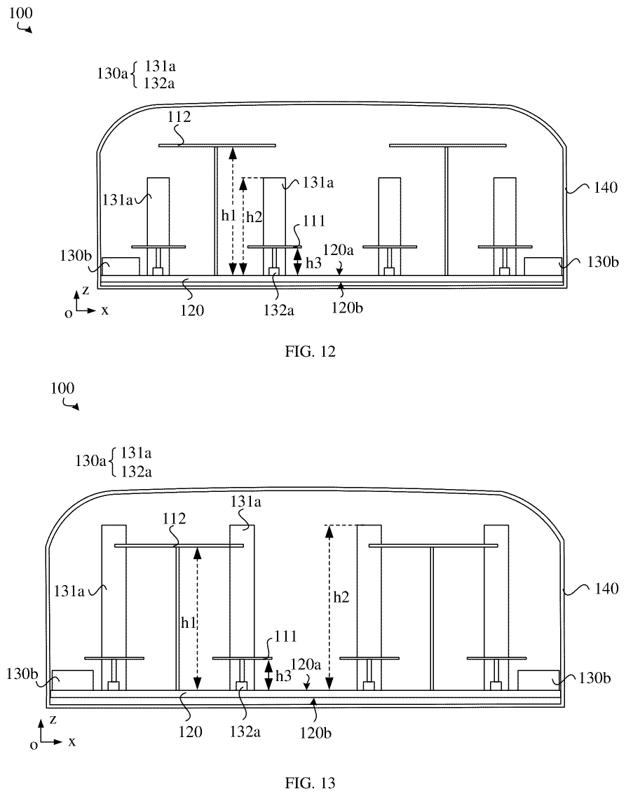

In some embodiments, as shown in FIG. 12, a height h2 of the phase shift apparatus 131a in the direction z may be less than the height h1 of the second radiating element 112 in the direction z and greater than the height h3 of the first radiating element 111 in the direction z. In this way, when the phase shift apparatus 131a is disposed in the direction z, a height of the antenna apparatus 100 in the direction z is not affected, to facilitate miniaturization development of the antenna apparatus 100, and reduce electromagnetic interference of the phase shift apparatus 131a to the first radiating element 111 and the second radiating element 112.

Certainly, in another embodiment, as shown in FIG. 13, the height h2 of the phase shift apparatus 131a in the direction z may alternatively be greater than the height h3 of the first radiating element 111 in the direction z and greater than the height h1 of the second radiating element 112 in the direction z. In this way, the phase shift apparatus 131a, the first radiating element 111, and the second radiating element 112 can share a partial cross-sectional height, and a cross-sectional height of the entire antenna apparatus 100 can be reduced by about 40%.

It should be noted that the height h2 of the phase shift apparatus 131a is not further limited in this embodiment of this application, and may be specifically set based on a specific case.

In a possible implementation, a plurality of second radiating elements 112 are spaced apart on the first surface 120a, and each second radiating element 112 is connected to the second feeding network 130b. The second feeding network 130b and the plurality of second radiating elements 112 connected to the same second feeding network 130b jointly form a second array unit 180. For example, as shown in FIG. 11, second radiating elements 112 disposed in a same row in the direction y form one second array unit 180.

It should be noted that, a quantity of second radiating elements 112 in one second array unit 180 is not limited, and may be set based on installation space on the reflection panel 120. Details are not described herein.

In some embodiments, at least one second array unit 180 is disposed between two adjacent first array units 170, and there is a second gap h between an end that is of the second array unit 180 and that is close to the reflection panel 120 and each of the two adjacent first array units 170. For example, the antenna apparatus 100 includes four first array units 170 and two second array units 180. The two second array units 180 are respectively disposed in first gaps L close to two end parts of the reflection panel 120 in the direction x.

Certainly, in another embodiment, three second array units 180 may be disposed, and one second array unit 180 is disposed in each first gap L. A quantity of second array units 180 is not further limited in this embodiment of this application, and may be specifically determined based on the capacity of the antenna apparatus 100.

The second array unit 180 is disposed, so that a frequency coverage area of the antenna apparatus 100 can be improved, to obtain better radiation directivity, thereby improving a radiation efficiency of the antenna apparatus 100, and improving performance of the antenna apparatus 100. The second gap h is disposed between two adjacent second array units 180, so that signal interference between two adjacent second array units 180 can be reduced, thereby improving performance of the antenna apparatus 100.

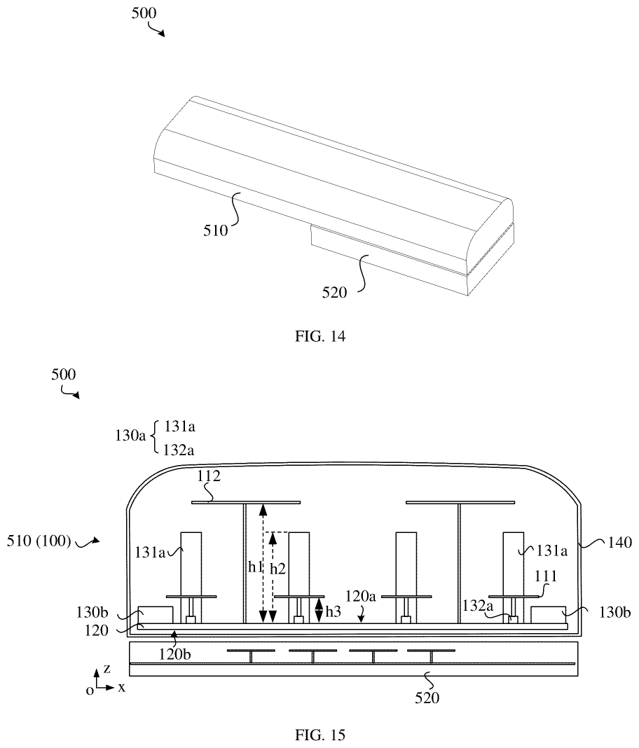

According to a second aspect, an embodiment of this application provides an antenna system 500. As shown in FIG. 14, the antenna system 500 includes the foregoing antenna apparatus 100. For ease of description, the antenna apparatus 100 in the first aspect is used as a first antenna apparatus 510. The antenna system 500 further includes a second antenna apparatus 520.

The antenna system 500 is disposed to include the first antenna apparatus 510 and the second antenna apparatus 520, so that a plurality of antenna apparatuses are designed in a fusion manner, to facilitate full-frequency-band coverage of the antenna apparatus.

In a possible implementation, the first antenna apparatus 510 is a passive antenna apparatus, and the second antenna apparatus 520 is an active antenna apparatus. The first antenna apparatus 510 is disposed as the passive antenna apparatus, and the second antenna apparatus 520 is disposed as the active antenna apparatus, so that an active antenna and a passive antenna are designed in a fusion manner, to facilitate full-frequency-band coverage of the antenna apparatus.

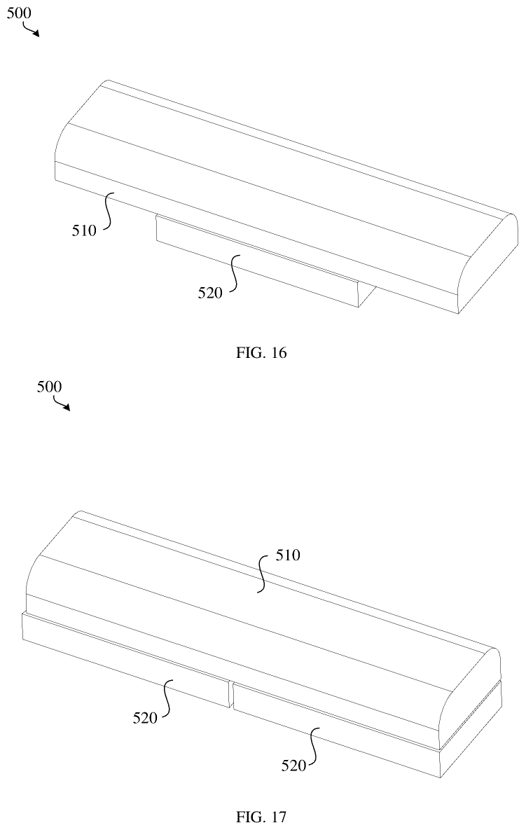

In a possible implementation, as shown in FIG. 15, the second antenna apparatus 520 is disposed opposite to the second surface 120b of the reflection panel 120 of the first antenna apparatus 510, there is a gap between the second antenna apparatus 520 and the second surface 120b, and the first surface 120a and the second surface 120b face away from each other. A field strength direction of an effective electric field of the second antenna apparatus 520 is parallel to the reflection panel 120, and the second antenna apparatus 520 transmits an electromagnetic wave in a direction close to the first radiating element 111 in the direction (direction z) perpendicular to the reflection panel 120.

The phase shift apparatus 131a of the first feeding network 130a of the first antenna apparatus 510 is disposed at the included angle with the reflection panel 120, so that a projection area of the phase shift apparatus 131a on the reflection panel 120 can be reduced, in other words, an overlapping area of projections of the phase shift apparatus 131a of the first antenna apparatus 510 and the second antenna apparatus 520 on the reflection panel 120 can be reduced. In this way, when the second antenna apparatus 520 transmits an electromagnetic wave in the direction perpendicular to the reflection panel 120 in a plane parallel to the reflection panel 120, interference of the phase shift apparatus 131a to radiation of an active antenna signal can be reduced, in other words, interference of the passive antenna to the active antenna is small in this embodiment of this application, thereby improving performance of the antenna system.

For example, the second antenna apparatus 520 may be installed on an outer side of the radome 140 of the first antenna apparatus 510 through fastening, there is a gap between the second antenna apparatus 520 and the radome 140, and the second antenna apparatus 520 is fastened to the radome 140.

It should be noted that a fastening manner between the second antenna apparatus 520 and the radome 140 is not further limited in this embodiment of this application, provided that fastening can be implemented. In addition, neither a value of the gap between the second antenna apparatus 520 and the reflection panel 120 nor a value of the gap between the second antenna apparatus 520 and the radome 140 is not further limited.

In a possible implementation, the reflection panel 120 of the first antenna apparatus 510 is a frequency selective surface. The reflection panel 120 of the first antenna apparatus 510 is disposed as the frequency selective surface, so that the reflection panel 120 can transmit a signal of the second antenna apparatus 520 and reflect a signal of the first antenna apparatus 510 (the first radiating element 111 and the second radiating element 112), thereby improving performance of the antenna system.

It should be noted that the frequency selective surface (FSS) is a single-screen or multi-screen periodic array structure including a large quantity of passive resonance units, and includes metal patch units periodically arranged or aperture units periodically arranged on a metal screen. This surface may present a total reflection (of a patch type) or total transmission (of an aperture type) characteristic near a unit resonance frequency, thereby achieving an effect of transmitting the signal of the second antenna apparatus 520 and reflecting the signal of the passive antenna (the first radiating element 111 and the second radiating element 112).

It should be noted that, in some embodiments, as shown in FIG. 15, the second antenna apparatus 520 may be disposed at one end of the antenna apparatus 100 in the direction y. For example, the second antenna apparatus 520 may be disposed at an end that is of the reflection panel 120 and at which fewer first radiating elements 111 and second radiating elements 112 are disposed. In this way, interference between the second antenna apparatus 520 and the first radiating element 111 and the second radiating element 112 can be reduced.

Certainly, in some embodiments, the second antenna apparatus 520 may alternatively be disposed at an end that is of the reflection panel 120 and at which more first radiating elements 111 and second radiating elements 112 are disposed, or may be disposed near a middle position of the reflection panel 120 in the direction y (referring to FIG. 16). A disposition position of the second antenna apparatus 520 is not limited in this embodiment of this application. Specifically, the second antenna apparatus 520 may be disposed based on sizes of the second antenna apparatus 520 and the reflection panel. Details are not described in this embodiment of this application.

In addition, a quantity of second antenna apparatuses 520 is not limited in this embodiment of this application. The quantity of second antenna apparatuses 520 may be 1, 2 (referring to FIG. 17), or 3. This may be specifically set based on a specific case. Details are not described in this embodiment of this application.

It should be noted that, a radiation frequency of the second antenna apparatus 520 may be different from the radiation frequency of the first radiating element 111 and the radiation frequency of the second radiating element 112. In this way, a bandwidth of the antenna apparatus 100 can be improved, to facilitate full-frequency-band coverage. In this embodiment of this application, the radiation frequency of the second antenna apparatus 520 is not further limited.

It should be understood that, in this application, the “electrical connection” may be understood as a physical contact and electrical conduction between components, or a coupled connection, or may be understood as a form in which different components in a line structure are connected through a physical line that can transmit an electrical signal, such as a printed circuit board (PCB) copper foil or conducting wire. The “coupling” may be understood as electrical conduction through air in an indirect coupling manner. The coupling in this application may be understood as capacitive coupling. For example, an equivalent capacitor is formed through coupling between gaps of two electric-conductors, to implement signal transmission. A person skilled in the art may understand that a coupling phenomenon is a phenomenon that inputs and outputs of two or more circuit components or electrical networks closely cooperate with each other and affect each other and energy is transmitted from one side to the other side through interaction. A “communication connection” may be electrical signal transmission, and includes a wireless communication connection and a wired communication connection. The wireless communication connection does not require a physical medium and does not belong to a connection relationship that defines a construction of a product. Both the “connection” and the “interconnection” may indicate a mechanical connection relationship or a physical connection relationship. To be specific, a connection between A and B or an interconnection between A and B may indicate that there is a fastening piece (such as a screw, a bolt, or a rivet) between A and B, or A and B are in contact with each other and A and B are difficult to be separated. For opposite/disposed opposite to each other, that A is disposed opposite to B may indicate that A and B are disposed opposite to each other or face to face (opposite to each other or face to face).

In description of embodiments of this application, it should be noted that, unless otherwise clearly specified and limited, the term “installation”, “interconnection”, or “connection” should be understood in a broad sense, for example, may be fastening, may be an indirect connection through an intermediate medium, or may be an internal connection between two components or an interaction relationship between two components. A person of ordinary skill in the art may understand specific meanings of the foregoing terms in embodiments of this application based on specific cases.

In the specification, claims, and accompanying drawings of embodiments of this application, the terms “first”, “second”, “third”, “fourth”, and the like (if existent) are intended to distinguish between similar objects but do not necessarily describe a specific order or sequence.

1. An antenna apparatus, comprising a reflection panel, a first feeding network, and a first radiating element, wherein the first radiating element is electrically connected to the first feeding network, and both the first feeding network and the first radiating element are located on a first surface of the reflection panel; and
the first feeding network comprises a phase shift apparatus, and the phase shift apparatus is disposed at an included angle with the reflection panel.

2. The antenna apparatus according to claim 1, wherein the phase shift apparatus comprises a housing; and
the housing is disposed at the included angle with the reflection panel.

3. The antenna apparatus according to claim 2, wherein a side wall of the housing encloses a cavity structure; and
a partition board is disposed in the cavity structure, the partition board divides the cavity structure into a plurality of accommodating cavities, and a phase shift medium is disposed in each accommodating cavity.

4. The antenna apparatus according to claim 3, wherein each partition board is disposed at the included angle with the reflection panel; and
the phase shift medium is movably disposed in a direction of forming the included angle with the reflection panel.

5. The antenna apparatus according to claim 1, wherein the included angle is 90°.

6. The antenna apparatus according to claim 1 wherein the first feeding network further comprises a signal transmission part; and
the signal transmission part is electrically connected to the phase shift apparatus, and the first radiating element is electrically connected to the signal transmission part.

7. The antenna apparatus according to claim 6, wherein at least a partial structure of the signal transmission part is parallel to the first surface of the reflection panel.

8. The antenna apparatus according to claim 6, wherein a groove structure is disposed on the first surface of the reflection panel; and
an extension direction of the groove structure is the same as an extension direction of the signal transmission part on the reflection panel, and the signal transmission part is located in the groove structure.

9. The antenna apparatus according to claim 6, wherein there are a plurality of first radiating elements; and
the plurality of first radiating elements are spaced apart in a direction in which the signal transmission part is located, and each first radiating element is electrically connected to the signal transmission part.

10. The antenna apparatus according to claim 9, wherein the first feeding network and the plurality of first radiating elements connected to the first feeding network jointly form a first array unit; and
the phase shift apparatus is located between two adjacent first radiating elements in the first array unit.

11. The antenna apparatus according to claim 6, wherein the signal transmission part comprises a plurality of signal transmission lines; and
each first radiating element corresponds to one signal transmission line, one end of the signal transmission line is electrically connected to the phase shift apparatus, and the other end is electrically connected to the first radiating element.

12. The antenna apparatus according to claim 1, further comprising a second radiating element and a second feeding network;
both the second radiating element and the second feeding network are located on the first surface of the reflection panel, and the second radiating element is electrically connected to the second feeding network; and
a radiation frequency of the first radiating element is different from a radiation frequency of the second radiating element.

13. The antenna apparatus according to claim 12, wherein a plurality of second radiating elements are spaced apart on the first surface, and each second radiating element is connected to the second feeding network.

14. The antenna apparatus according to claim 1, wherein the phase shift apparatus is fastened to the reflection panel.

15. A communication device, comprising an antenna apparatus and a radio frequency unit, wherein the antenna apparatus is connected to the radio frequency unit;
wherein the antenna apparatus comprises a reflection panel, a first feeding network, and a first radiating element, wherein the first radiating element is electrically connected to the first feeding network, and both the first feeding network and the first radiating element are located on a first surface of the reflection panel; and
the first feeding network comprises a phase shift apparatus, and the phase shift apparatus is disposed at an included angle with the reflection panel.

16. The communication device according to claim 15, wherein the phase shift apparatus comprises a housing; and
the housing is disposed at the included angle with the reflection panel.

17. The communication device according to claim 16, wherein a side wall of the housing encloses a cavity structure; and
a partition board is disposed in the cavity structure, the partition board divides the cavity structure into a plurality of accommodating cavities, and a phase shift medium is disposed in each accommodating cavity.

18. The communication device according to claim 17, wherein each partition board is disposed at the included angle with the reflection panel; and
the phase shift medium is movably disposed in a direction of forming the included angle with the reflection panel.

19. The communication device according to claim 15, wherein the included angle is 90°.

20. The communication device according to claim 15 wherein the first feeding network further comprises a signal transmission part; and
the signal transmission part is electrically connected to the phase shift apparatus, and the first radiating element is electrically connected to the signal transmission part.
